(19) United States
(12) Patent Application Publication
(10) Pub. No.: US 2017/0320769 A1
(43) Pub. Date: Nov. 9, 2017

(54) GLASS COMPOSITIONS THAT RETAIN HIGH COMPRESSIVE STRESS AFTER POST-ION EXCHANGE HEAT TREATMENT

(71) Applicant: CORNING INCORPORATED, Corning, NY (US)

(72) Inventors: Xiaoju Guo, Painted Post, NY (US); John Christopher Mauro, Corning, NY (US)

(21) Appl. No.: 15/581,616

(22) Filed: Apr. 28, 2017

Related U.S. Application Data
(60) Provisional application No. 62/332,591, filed on May 6, 2016.

(51) Int. Cl. C03C 3/085; C03C 4/18; C03C 21/00

(52) U.S. Cl. CPC C03C 3/085; C03C 21/002; C03C 4/18; C03C 2204/00

(57) ABSTRACT

Ion exchangeable glasses containing SiO₂, Na₂O, MgO, and, optionally, at least one of Li₂O and ZrO₂. These glasses are also free of at least one of B₂O₃, K₂O, CaO, and P₂O₅. These glasses may be ion-exchanged to achieve a depth of compressive layer of at least about 40 μm or up to about 50 μm and a maximum surface compressive stress of at least about 950 MPa, in some embodiments, at least 1000 MPa and, in other embodiments, at least about 1100 MPa. The ion-exchanged glasses, when subsequently heat-treated, have a retained compressive stress of at least about 600 MPa at the surface of the glass and, in some embodiments, at least about 750 MPa. The glasses also exhibit high levels of durability when exposed to strong acid.

### CROSS-REFERENCE TO RELATED APPLICATIONS

This application claims the benefit of priority under 35 U.S.C. §120 of U.S. Application Ser. No. 62/332,591 filed on May 6, 2016 the content of which is relied upon and incorporated herein by reference in its entirety.

### BACKGROUND

The disclosure relates to ion exchangeable glasses. More particularly, the disclosure relates to glasses which, when ion-exchanged and subsequently heat-treated, retain surface compressive stress. Even more particularly, the disclosure relates to such ion exchangeable glasses having high levels of durability.

In contrast to chemically strengthened glass for the consumer electronic market, glass used in architectural applications, such as multi-pane windows, typically undergo a sealing process following ion exchange. During the sealing process, the ion-exchanged glass is heated up to a temperature at which diffusion and stress relaxation are both significant. Thus, the stress relaxation caused by the heating step in the sealing process significantly reduces the compressive stress CS achieved at the glass surface by the ion exchange process, as the K⁺ ions introduced during ion exchange continue to diffuse deeper into the glass during subsequent heat treatments. In some glasses, for example, the compressive stress at the glass surface will be reduced from 900 MPa to below 600 MPa after post-ion exchange thermal treatment.

### SUMMARY

The present disclosure provides ion exchangeable glasses containing SiO₂, Na₂O, MgO, and, optionally, at least one of Li₂O and ZrO₂. In addition, these glasses are free of at least one of B₂O₃, K₂O, CaO, and P₂O₅. These glasses may be ion-exchanged to achieve a depth of compressive layer of at least about 40 μm, or up to about 50 μm, or up to about 70 μm and a maximum surface compressive stress of at least about 950 MPa, in some embodiments, at least 1000 MPa and, in other embodiments, at least about 1100 MPa. The ion-exchanged glasses, when subsequently heat-treated, have a retained compressive stress of at least about 600 MPa at the surface of the glass and, in some embodiments, at least about 750 MPa. The glasses also exhibit high levels of durability when exposed to strong acid.

A first aspect of the disclosure is to provide an alkali aluminosilicate glass that comprises at least about 50 mol % SiO2, at least about 10 mol % Na₂O, and MgO and is free of at least one of B₂O₃, K₂O, CaO, BaO, and P₂O₅. The alkali aluminosilicate glass experiences a weight loss of less than or equal to about 0.030 mg/cm² after immersion at 95° C. for about 7 hours in an acid solution comprising about 5 wt % HCl.

A second aspect according to the first aspect, wherein the alkali aluminosilicate glass has a thickness t of up to about 1 mm and has a compressive layer extending from a surface of the alkali aluminosilicate glass to a depth of layer of up to about 70 μm and a maximum compressive stress of at least about 950 MPa at the surface.

A third aspect according to the second aspect, wherein the compressive stress is at least about 1000 MPa and a depth of layer of at least about 40 μm.

A fourth aspect according to the second aspect, wherein the alkali aluminosilicate glass has been heat treated at a temperature of at least about 450° C. following ion exchange and wherein the alkali aluminosilicate glass has a compressive stress at the surface of at least 600 MPa.

A fifth aspect according to any one of the second through fourth aspects, wherein the alkali aluminosilicate glass is ion-exchanged and wherein the compressive layer comprises a near-surface region extending from the surface to a depth of 0.20t, and wherein the near-surface region comprises up to about 10 mol % K₂O.

A sixth aspect according to any of the preceding aspects, wherein the alkali aluminosilicate glass comprises from about 0.25 mol % to about 6 mol % Li₂O.

A seventh aspect according to any of the preceding aspects, wherein the alkali aluminosilicate glass comprises from about 0.5 mol % to about 5 mol % ZrO₂.

An eighth aspect according to any of the preceding aspects, wherein the alkali aluminosilicate glass comprises: from about 50 mol % to about 75 mol % SiO₂; from about 7 mol % to about 26 mol % Al₂O₃; from 0 mol % to about 6 mol % Li₂O; from about 10 mol % to about 25 mol % Na₂O; and greater than 0 mol % to about 8 mol % MgO.

A ninth aspect according to any of the preceding aspects, wherein the alkali aluminosilicate glass comprises: from about 60 mol % to about 75 mol % SiO₂; from about 7 mol % to about 15 mol % Al₂O₃; from 0 mol % to about 4 mol % Li₂O; from about 10 mol % to about 16 mol % Na₂O; from about 4 mol % to about 6 mol % MgO; from 0 mol % to about 3 mol % ZnO; and from 0 mol % to about 3 mol % ZrO₂.

A tenth aspect according to any of the preceding aspects, wherein MgO+CaO+SrO+BaO+ZnO≦8 mol %.

An eleventh aspect according to any of the preceding aspects, wherein the alkali aluminosilicate glass forms at least a portion of an architectural element or an article with a display.

A twelfth aspect of the disclosure is to provide an alkali aluminosilicate glass comprising Na₂O and MgO, wherein the alkali aluminosilicate glass has a thickness t of up to about 1 mm. The alkali aluminosilicate glass is ion-exchanged, and has a compressive layer extending from a surface of the alkali aluminosilicate glass to a depth of layer of up to about 70 μm and a maximum compressive stress of at least about 950 MPa at the surface. The alkali aluminosilicate glass experiences a weight loss of less than or equal to about 0.030 mg/cm² after immersion at 95° C. for about 7 hours in an acid solution comprising about 5 wt % HCl.

A thirteenth aspect according to the twelfth aspect, wherein the maximum compressive stress is at least about 1000 MPa.

A fourteenth aspect according to the twelfth aspect, wherein the alkali aluminosilicate glass has been heat treated at a temperature of at least about 450° C. following ion exchange and wherein the alkali aluminosilicate glass has a compressive stress at the surface of at least 600 MPa.

A fifteenth aspect according to any of the twelfth through fourteenth aspects, wherein the alkali aluminosilicate glass comprises from about 0.25 mol % to about 6 mol % Li₂O.

A sixteenth aspect according to any one of the twelfth through fifteenth aspects, wherein the compressive layer comprises a near-surface region extending from the surface to a depth of 0.20t, and wherein the near-surface region comprises up to about 10 mol % K₂O.

A seventeenth aspect according to any one of the twelfth through sixteenth aspects, wherein the alkali aluminosilicate glass comprises: from about 50 mol % to about 75 mol % SiO₂; from about 7 mol % to about 26 mol % Al₂O₃; from 0 mol % to about 6 mol % Li₂O; from about 10 mol % to about 25 mol % Na₂O; and greater than 0 mol % to about 8 mol % MgO.

An eighteenth aspect according to any one of the twelfth through seventeenth aspects, wherein the alkali aluminosilicate glass comprises: from about 60 mol % to about 75 mol % SiO₂; from about 7 mol % to about 15 mol % Al₂O₃; from 0 mol % to about 4 mol % Li₂O; from about 10 mol % to about 16 mol % Na₂O; from about 4 mol % to about 6 mol % MgO; from 0 mol % to about 3 mol % ZnO; and from 0 mol % to about 3 mol % ZrO₂.

A nineteenth aspect according to any one of the twelfth through eighteenth aspects, wherein MgO+CaO+SrO+BaO+ZnO≦8 mol %.

A twentieth aspect according to any one of the twelfth through nineteenth aspects, wherein the alkali aluminosilicate glass forms at least a portion of an architectural element or an article with a display.

A twenty-first aspect of the disclosure is to provide an alkali aluminosilicate glass comprising: from about 60 mol % to about 75 mol % SiO₂; from about 7 mol % to about 15 mol % Al₂O₃; from about 0.25 mol % to about 4 mol % Li₂O; from about 10 mol % to about 16 mol % Na₂O; from about 4 mol % to about 6 mol % MgO; from 0 mol % to about 3 mol % ZnO; from 0.5 mol % to about 3 mol % ZrO₂; and free of at least one of K₂O and CaO.

A twenty-second aspect according to the twenty-first aspect, wherein the alkali aluminosilicate glass is free of at one or more of B₂O₃, K₂O, CaO, and P₂O₅.

A twenty-third aspect according to the twenty-first or twenty-second aspect, wherein MgO+CaO+SrO+BaO+ZnO≦8 mol %.

A twenty-fourth aspect according to any of the twenty-first through twenty-third aspects, wherein the alkali aluminosilicate glass is ion exchangeable to achieve a compressive layer extending from a surface to the depth of layer and having a compressive stress at the surface of at least about 950 MPa.

A twenty-fifth aspect according to the twenty-fourth aspect, wherein the compressive stress is at least about 1000 MPa.

A twenty-sixth aspect according to the twenty-fourth or twenty-fifth aspect, wherein the alkali aluminosilicate glass is ion-exchanged and wherein the compressive layer comprises a near-surface region extending from the surface to a depth of 0.20t, and wherein the near-surface region comprises up to about 10 mol % K₂O.

A twenty-seventh aspect according any of the twenty-first through twenty-sixth aspects, wherein the alkali aluminosilicate glass experiences a weight loss of less than or equal to about 0.030 mg/cm² after immersion in an acid solution at 95° C. for about 7 hours, the acid solution comprising about 5 wt % HCl.

A twenty-eighth aspect according any of the twenty-first through twenty-seventh aspects, wherein the alkali aluminosilicate glass forms at least a portion of an architectural element or an article with a display.

A twenty-ninth aspect of the disclosure is to provide a method of ion exchanging an alkali aluminosilicate glass. The method comprises the steps of: ion exchanging alkali aluminosilicate glass in an ion exchange bath comprising a potassium-containing salt, wherein the ion-exchanged alkali aluminosilicate glass has a compressive layer having a depth of layer of a compressive layer of about 0.25t or less, and a compressive stress at a surface of the alkali aluminosilicate glass of at least about 950 MPa; and heat treating the ion-exchanged alkali aluminosilicate glass at a temperature of at least about 400° C., wherein the compressive stress at the surface of the ion-exchanged alkali aluminosilicate glass after the heat treating step is at least about 600 MPa.

A thirtieth aspect according to the twenty-ninth aspect, wherein the compressive stress at the surface of the ion-exchanged alkali aluminosilicate glass after the heat treating step is at least about 750 MPa.

These and other aspects, advantages, and salient features will become apparent from the following detailed description, the accompanying drawings, and the appended claims.

### BRIEF DESCRIPTION OF THE DRAWINGS

FIG. 1 is a cross-sectional schematic view of an ion-exchanged glass article;

FIG. 2 is a plot of compressive stress CS and depth of layer DOL of ion-exchanged glasses;

FIG. 3 is a plot of compressive stresses and depths of layer of heat-treated ion-exchanged glasses; and

FIG. 4 is a plot of chemical durability of glasses.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any ranges therebetween. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

As used herein, the terms “glass article” and “glass articles” are used in their broadest sense to include any object made wholly or partly of glass. Unless otherwise specified, all compositions are expressed in terms of mole percent (mol %). Coefficients of thermal expansion (CTE) are expressed in terms of 10⁻⁷/° C. and represent a value measured over a temperature range from about 20° C. to about 300° C., unless otherwise specified.

As used herein, the term “liquidus temperature,” or “T^{L}” refers to the temperature at which crystals first appear as a molten glass cools down from the melting temperature, or the temperature at which the very last crystals melt away as temperature is increased from room temperature. As used herein, the term “35 kP temperature” or “T^{35kP}” refers to the temperature at which the glass or glass melt has a viscosity of 35,000 Poise (P), or 35 kiloPoise (kP).

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Thus, a glass that is “free of K₂O” is one in which K₂O is not actively added or batched into the glass, but may be present in very small amounts as a contaminant; e.g., 400 parts per million (ppm) or less or, in some embodiments, 300 ppm or less.

Compressive stress and depth of layer are measured using those means known in the art. Such means for compressive stress at the surface include, but are not limited to, measurement of surface stress (FSM) using commercially available instruments such as the FSM-6000, manufactured by Orihara Co., Ltd. (Tokyo, Japan). Surface stress measurements rely upon the accurate measurement of the stress optical coefficient (SOC), which is related to the birefringence of the glass. SOC values can be measured as set forth in Procedure C (Glass Disc Method) of ASTM standard C770-16, entitled “Standard Test Method for Measurement of Glass Stress-Optical Coefficient.” DOL values can be measured using a scattered light polariscope (SCALP) technique known in the art.

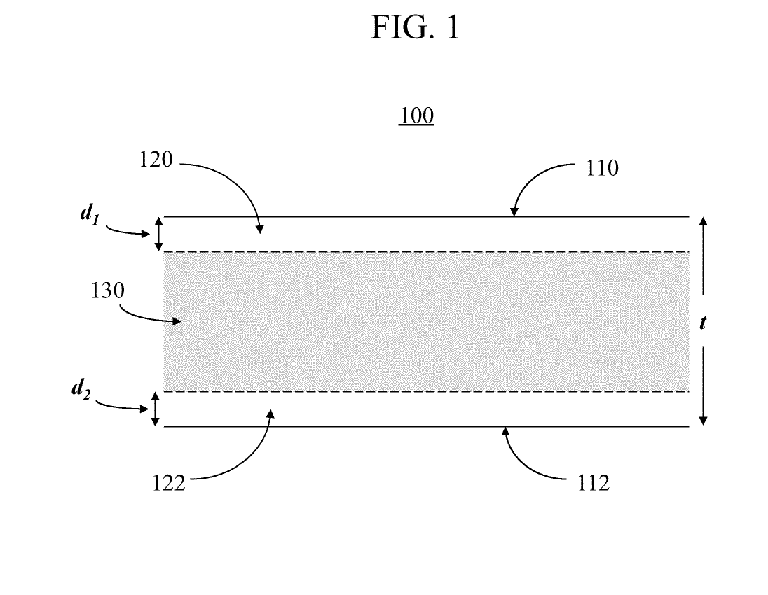

Referring to the drawings in general and to FIG. 1 in particular, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

Described herein are alkali aluminosilicate glasses containing SiO₂, Al₂O₃, Na₂O, and MgO. In some embodiments, the glasses additional include at least one of Li₂O, ZrO₂, and ZnO. In addition, these glasses, when initially formed, are free of at least one of B₂O₃, K₂O, CaO, BaO, and P₂O₅. In some embodiments, these glasses, when initially formed, are free of one or more of B₂O₃, K₂O, CaO, BaO, and P₂O₅. A small amount of K₂O may, however, be introduced during ion exchange of these glasses.

The glasses described herein comprise at least about 50 mol % SiO₂ and at least about 10 mol % Na₂O. These glasses, in some embodiments, comprise: at least about 50 mol % to about 75 mol % SiO₂ (50 mol %≦SiO₂≦75 mol %) from about 7 mol % to about 26 mol % Al₂O₃ (7 mol %≦Al₂O₃≦26 mol %); from 0 mol % to about 6 mol % Li₂O (0 mol %≦Li₂O≦6 mol %); from about 10 mol % to about 25 mol % Na₂O (10 mol %≦Na₂O≦25 mol %); and from greater than 0 mol % to about 8 mol % MgO (0 mol %<MgO≦8 mol %). In some embodiments, these glasses may further comprise up to about 6 mol % CaO (0 mol %≦CaO≦6 mol %).

In some embodiments, the alkali aluminosilicate glasses described herein comprise: from about 60 mol % to about 75 mol % SiO₂ (60 mol %≦SiO₂≦75 mol %); from about 7 mol % to about 15 mol % Al₂O₃ (7 mol %≦Al₂O₃≦15 mol %); from 0 mol % to about 4 mol % Li₂O (0 mol %≦Li₂O≦4 mol %); from about 10 mol % to about 16 mol % Na₂O (10 mol %≦Na₂O≦16 mol %); from about 4 mol % to about 6 mol % MgO (4 mol %≦MgO≦6 mol %); from 0 mol % to about 3 mol % ZnO (0 mol %≦ZnO≦3 mol %); and from 0 mol % to about 3 mol % ZrO₂ (0 mol %≦ZrO₂≦3 mol %). In some embodiments, the total amount of divalent oxides glasses comprise up to about 8 mol % of the glass (i.e., MgO+CaO+SrO+BaO+ZnO≦8 mol %).

In some embodiments, the glass may further include less than about 1 mol % SnO₂ (0 mol %≦SnO₂<1 mol %) and, in other embodiments, up to about 0.16 mol % SnO₂ (0 mol %≦SnO₂≦0.16 mol %), as a fining agent.

Table 1 lists non-limiting, exemplary compositions of the alkali aluminosilicate glasses described herein. The compositions listed in Table 1 are “as batched” and were determined using x-ray fluorescence. Table 2 lists selected physical properties determined for the examples listed in Table 1. The physical properties listed in Table 2 include: density; low temperature CTE; strain, anneal and softening points; fictive (10¹¹ Poise) temperature; zircon breakdown and liquidus viscosities; Poisson's ratio; Young's modulus; shear modulus; refractive index; and stress optical coefficient (SOC). Anneal, strain and softening points were determined by fiber elongation. Densities were determined by the buoyancy method of ASTM C693-93(2013). Coefficients of thermal expansion (CTE) listed in Table 2 represent the average value between room temperature and 300° C. and was determined using a push-rod dilatometer in accordance with ASTM E228-11. The stress optic coefficient (SOC) was measured as set forth in Procedure C (Glass Disc Method) of ASTM standard C770-16, entitled “Standard Test Method for Measurement of Glass Stress-Optical Coefficient.” The liquidus viscosity is determined by the following method. First the liquidus temperature of the glass is measured in accordance with ASTM C829-81 (2015), titled “Standard Practice for Measurement of Liquidus Temperature of Glass by the Gradient Furnace Method”. Next the viscosity of the glass at the liquidus temperature is measured in accordance with ASTM C965-96(2012), titled “Standard Practice for Measuring Viscosity of Glass Above the Softening Point”. Liquidus temperatures were determined using 72 hour temperature hold in a gradient boat. Zircon breakdown temperatures were determined using 168 hour temperature holds in a gradient boat. The strain point and annealing point were determined using the beam bending viscosity method of ASTM C598-93(2013). The softening point was determined using the parallel plate viscosity method of ASTM C1351M-96(2012). The Poisson ratio values, shear modulus values, and Young's modulus values recited in this disclosure refer to values as measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts.”

Table 1
Examples of alkali aluminosilicate glass compositions described herein, expressed in mol %.

| Sample | Control | 1 | 2 | 3 | 4 | 5 | 6 | 7 | 8 | 9 | 10 | 11 | 12 |
|---|---|---|---|---|---|---|---|---|---|---|---|---|---|
| SiO₂ | 68.99 | 69.02 | 69.73 | 68.97 | 68.09 | 68.74 | 67.85 | 67.09 | 67.16 | 67.07 | 66.75 | 66.70 | 66.79 |
| Al₂O₃ | 10.27 | 10.48 | 10.56 | 10.48 | 10.47 | 10.57 | 10.52 | 10.53 | 10.48 | 10.49 | 10.62 | 10.60 | 10.59 |
| Li₂O | 0.00 | 1.00 | 0.00 | 0.00 | 0.99 | 0.00 | 0.00 | 1.00 | 1.98 | 3.97 | 1.02 | 2.02 | 3.01 |
| Na₂O | 15.20 | 13.84 | 13.98 | 13.88 | 13.84 | 13.98 | 13.92 | 13.79 | 12.79 | 10.90 | 12.99 | 12.02 | 11.03 |
| MgO | 5.37 | 5.47 | 5.52 | 5.45 | 5.45 | 5.53 | 5.51 | 5.46 | 5.45 | 5.44 | 5.52 | 5.54 | 5.47 |
| ZnO | 0.00 | 0.00 | 0.00 | 1.03 | 0.00 | 0.01 | 1.03 | 0.00 | 0.00 | 0.00 | 0.00 | 0.00 | 0.00 |
| ZrO₂ | 0.00 | 0.00 | 0.00 | 0.00 | 0.98 | 0.99 | 0.97 | 1.94 | 1.95 | 1.95 | 2.92 | 2.93 | 2.93 |
| SnO₂ | 0.17 | 0.16 | 0.17 | 0.17 | 0.16 | 0.16 | 0.16 | 0.16 | 0.16 | 0.16 | 0.16 | 0.16 | 0.15 |

TABLE 2
Selected physical properties of the glasses listed in Table 1.

| Sample | 1 | 2 | 3 | 4 | 5 | 6 |
|---|---|---|---|---|---|---|
| Strain point | 574 | 607 | 616 | 594 | 624 | 630 |
| (° C.) | | | | | | |
| Anneal point | 627 | 660 | 670 | 647 | 678 | 683 |
| (° C.) | | | | | | |
| Softening | 880 | 907 | 918 | 894 | 923 | 928 |
| point (° C.) | | | | | | |
| Density | 2.435 | 2.44 | 2.449 | 2.467 | 2.471 | 2.482 |
| (mg/cm³) | | | | | | |
| Expansion | 79.4 | 76.7 | 76.4 | 77.9 | 75.4 | 75.1 |
| (×10⁻⁷/° C.) | | | | | | |
| SOC | 30.22 | 30.15 | 29.78 | 30.45 | 30.13 | 29.92 |
| RI | 1.50242 | 1.50283 | 1.50257 | 1.509156667 | 1.509376667 | 1.50932 |
| Shear | 4.62 | 4.73 | 4.84 | 4.75 | 4.85 | 4.92 |
| modulus | | | | | | |
| (GPa) | | | | | | |
| Young's | 11.21 | 11.37 | 11.79 | 11.6 | 11.84 | 11.93 |
| modulus | | | | | | |
| (GPa) | | | | | | |
| Poisson's ratio | 0.212 | 0.201 | 0.218 | 0.222 | 0.221 | 0.213 |
| Liquidus | 103391 | 31139 | 107431 | 115702 | 96034 | — |
| viscosity | | | | | | |
| (Poise) | | | | | | |
| T^{35KP} (° C.) | 1185 | 1208 | 1215 | 1188 | 1207 | — |
| Zircon | >1245 | 1230 | 1245 | 1200 | 1225 | 1225 |
| breakdown | | | | | | |
| T (° C.) | | | | | | |
| Sample | 7 | 8 | 9 | 10 | 11 | 12 |
| Strain | 617 | 598 | 577 | 631 | 614 | 604 |
| point (° C.) | | | | | | |
| Anneal | 670 | 651 | 627 | 683 | 666 | 654 |
| point (° C.) | | | | | | |
| Softening | 909 | 891 | 860 | 914 | 895 | 882 |
| point (° C.) | | | | | | |
| Density | 2.498 | 2.498 | 2.496 | 2.535 | 2.535 | 2.534 |
| (mg/cm³) | | | | | | |
| Expansion | 76.8 | 75.6 | 72.4 | 73.1 | 71.7 | 71.3 |
| (×10⁻⁷/° C.) | | | | | | |
| SOC | 29.88 | 30.15 | 30.88 | 30.1 | 30.34 | 30.91 |
| RI | 1.5157 | 1.5171 | 1.5197 | 1.5237 | 1.5255 | 1.5269 |
| Shear | 4.43 | 4.44 | 4.38 | 4.55 | 4.48 | 4.43 |
| modulus | | | | | | |
| (GPa) | | | | | | |
| Young's | 10.71 | 10.75 | 10.51 | 10.96 | 10.76 | 10.75 |
| modulus | | | | | | |
| (GPa) | | | | | | |
| Poisson's | 0.209 | 0.211 | 0.2 | 0.205 | 0.202 | 0.213 |
| ratio | | | | | | |
| Liquidus | — | — | — | — | — | — |
| viscosity | | | | | | |
| (Poise) | | | | | | |
| T^{35KP} (° C.) | 1190 | 1171 | 1139 | 1181 | 1163 | 1149 |
| Zircon | — | — | — | — | — | — |
| breakdown | | | | | | |
| T (° C.) | | | | | | |

Each of the oxide components of the base and ion-exchanged glasses described herein serves a function and/or has an effect on the manufacturability and physical properties of the glass. Silica (SiO₂) serves as the primary glass-forming oxide and provides the main structural element for the glass. The SiO₂ concentration should be sufficiently high in order to provide the glass with sufficiently high chemical durability. However, the melting temperature (i.e., the temperature at which the viscosity of the glass is 200 Poise, or 200 poise temperature (T^{200P})) of pure SiO₂ or high-SiO₂ glasses is too high, since defects such as fining bubbles may appear. Furthermore, compared to most oxides, SiO₂ decreases the compressive stress created by ion exchange. SiO₂ also adds free volume to the network structure of the glass, thereby increasing the amount of point contact deformation required to form strength limiting crack systems. In some embodiments, the glasses described herein comprise at least 50 mol % SiO₂, at least 51 mol % SiO₂, at least 52 mol % SiO₂, at least 53 mol % SiO₂, at least 54 mol % SiO₂, at least 55 mol % SiO₂, at least 56 mol % SiO₂, at least 57 mol % SiO₂, at least 58 mol % SiO₂, at least 59 mol % SiO₂, at least 60 mol % SiO₂, at least 61 mol % SiO₂, at least 62 mol % SiO₂, at least 63 mol % SiO₂, at least 64 mol % SiO₂, at least 65 mol % SiO₂, at least 66 mol % SiO₂, at least 67 mol % SiO₂, at least 68 mol % SiO₂, at least 69 mol % SiO₂, at least 70 mol % SiO₂, at least 71 mol % SiO₂, at least 72 mol % SiO₂, at least 73 mol % SiO₂, at least 74 mol % SiO₂, or 75 mol % SiO₂, and any ranges or subranges therebetween. In certain embodiments, the glasses described herein may comprise from about 50 to about 75 mol % SiO₂, or from about 60 mol % SiO₂ to about 70 mol % SiO₂, or from about 60 mol % SiO₂ to about 75 mol % SiO₂, or from about 66 to about 70 mol % SiO₂. In some embodiments, these glasses comprise up to about 72 mol % SiO₂ and, in still other embodiments, up to about 75 mol % SiO₂.

Alumina (Al₂O₃) can also serve as a glass former in the example glasses. Like SiO₂, Al₂O₃ generally increases the viscosity of the melt and an increase in Al₂O₃ relative to the alkalis or alkaline earths generally results in improved durability of the glass. The structural role of the aluminum ions depends on the glass composition. When the concentration of alkali oxide [R₂O] is equal to or greater than the concentration of alumina [Al₂O₃], all aluminum is found in tetrahedral coordination. Alkali ions charge compensate Al³⁺ ions, so they act as Al⁴⁺ ions, which favor tetrahedral coordination. This is the case for some of the example glasses de3scribed and listed herein. Alkali ions in excess of aluminum ions tend to form non-bridging oxygens. In other example glasses, the concentration of alkali oxide is less than the concentration of aluminum ions, in this case, divalent cation oxides (RO) can also charge balance tetrahedral aluminum to various extents. While elements such as calcium, strontium, and barium behave equivalently to two alkali ions, the high field strength of magnesium and zinc ions cause them to not fully charge balance aluminum in tetrahedral coordination, which may result in the formation of five- and six-fold coordinated aluminum. Al₂O₃ plays an important role in ion exchangeable glasses since it provides a strong network backbone (i.e., high strain point) while allowing for the relatively fast diffusivity of alkali ions. However, high Al₂O₃ concentrations generally lower the liquidus viscosity. The Al₂O₃ concentration thus needs to be limited to a reasonable range. In some embodiments, the glasses described herein may include at least 7 mol % Al₂O₃, at least 8 mol % Al₂O₃, at least 9 mol % Al₂O₃, at least 10 mol % Al₂O₃, at least 11 mol % Al₂O₃, at least 12 mol % Al₂O₃, at least 13 mol % Al₂O₃, at least 14 mol % Al₂O₃, at least 15 mol % Al₂O₃, at least 16 mol % Al₂O₃, at least 17 mol % Al₂O₃, at least 18 mol % Al₂O₃, at least 19 mol % Al₂O₃, at least 20 mol % Al₂O₃, at least 21 mol % Al₂O₃, at least 22 mol % Al₂O₃, at least 23 mol % Al₂O₃, at least 24 mol % Al₂O₃, at least 25 mol % Al₂O₃, or 26 mol % Al₂O₃, or any ranges or subranges therebetween. In some embodiments, the glasses described herein comprise from about 7 mol % to about 26 mol % Al₂O₃; in some embodiments, from about 7 mol % to about 15 mol % Al₂O₃; in other embodiments, from about 10 mol % to about 15 mol % Al₂O₃; and, in certain embodiments, from about 7 mol % to about 11 mol % Al₂O₃.

Alkali oxides (Li₂O, Na₂O, K₂O, Rb₂O, and Cs₂O) aid in achieving low melting temperature and low liquidus temperatures. On the other hand, the addition of alkali oxides dramatically increases the coefficient of thermal expansion (CTE) and lowers the chemical durability of the glass. Most importantly, to perform ion exchange, the presence of a small alkali oxide such as Li₂O and Na₂O is required to exchange with larger alkali ions (e.g., K⁺) that are present in an ion exchange salt bath. In particular, the presence of the highly mobile Na⁺ cation facilitates ion exchange in these glasses. K⁺for-Li⁺ exchange results in a small depth of the compressive layer but a relatively large surface compressive stress, whereas K⁺-for-Na⁺ exchange results in an intermediate depth of compressive layer and surface compressive stress. A sufficiently high concentration of the small alkali oxide is necessary to produce a large compressive stress in the glass, since compressive stress is proportional to the number of alkali ions that are exchanged out of the glass. In some embodiments, the glasses described herein comprise at least 10 mol % Na₂O, at least 11 mol % Na₂O, at least 12 mol % Na₂O, at least 13 mol % Na₂O, at least 14 mol % Na₂O, at least 15 mol % Na₂O, at least 16 mol % Na₂O, at least 17 mol % Na₂O, at least 18 mol % Na₂O, at least 19 mol % Na₂O, at least 20 mol % Na₂O, at least 21 mol % Na₂O, at least 22 mol % Na₂O, at least 23 mol % Na₂O, at least 24 mol % Na₂O, or 25 mol % Na₂O, or any ranges or subranges therebetween In some embodiments the glasses described herein include from about 10 mol % to about 25 mol % Na₂O; and in still other embodiments, from about 10 mol % to about 16 mol % Na₂O.

In some embodiments, Li₂O is added to further reduce diffusivity, enhance the compressive stress capability of the glass, increase modulus, and improve durability. In some embodiments, the glasses described herein include 0 mol % Li₂O, at least 0.25 mol % Li₂O, at least 0.5 mol % Li₂O, at least 0.75 mol % Li₂O, at least 1 mol % Li₂O, at least 2 mol % Li₂O, at least 3 mol % Li₂O, at least 4 mol % Li₂O, at least 5 mol % Li₂O, or 6 mol % Li₂O, or any ranges or subranges therebetween. In some embodiments, the glasses described herein comprises from 0 mol % to about 6 mol % Li₂O; in some embodiments, from in other embodiments, 0 mol % to about 4 mol % Li₂O; in some embodiments, from about 0.25 mol % to about 6 mol % Li₂O; in yet other embodiments, from about 0.25 mol % to about 6 mol % Li₂O; and, in still other embodiments, from about 0.5 mol % to about 5 mol % Li₂O.

It is generally desirable to maintain a high level of compressive stress in an ion-exchanged glass. Thus, an ion exchangeable glass with low diffusivity is desirable. Potassium ions tend to diffuse deep into the glass during subsequent heat treatments of the glass, thereby contributing to stress reduction in the glass. Accordingly, the glasses described herein as batched are free of K₂O. Some potassium may, however, be introduced into the glass as a result of the ion exchange process. The presence of potassium, which may be determined by x-ray fluorescence or electron microprobe techniques known in the art, is limited to a near-surface region (not shown) within the compressive layer (120, 122 in FIG. 1). The near-surface region may comprise up to about 10 mol % K₂O. In some embodiments, this near-surface region extends form the surface of the glass to a depth of about 50 μm. In other embodiments, the near-surface region extends from the surface to a depth equal to about 20% of the thickness t—i.e., 0.20t. At depths greater than 50 μm or, in some embodiments, greater than 0.20t, the glass is free of K₂O.

Divalent cation oxides (such as alkaline earth oxides and ZnO) also improve the melting behavior of the glass. With respect to ion exchange performance, however, the presence of divalent cations tends to decrease alkali mobility. The negative effect on ion exchange performance is especially pronounced with the larger divalent cations. Furthermore, the smaller divalent cation oxides generally help the compressive stress more than the larger ones. Hence, the addition of MgO and ZnO offer several advantages with respect to improved stress relaxation while minimizing the adverse effects on alkali diffusivity. However, when high amounts of MgO and ZnO are present in the glass, they are prone to form forsterite (Mg₂SiO₄) and gahnite (ZnAl₂O₄) or willemite (Zn₂SiO₄), thus causing the liquidus temperature to rise very steeply when the MgO and ZnO contents exceed a certain level. In some embodiments, MgO is the only divalent cation oxide present in the glasses described herein. In some embodiments, the glasses described herein contain from greater than 0 mol % up to about 8 mol % MgO and any ranges or subranges therebetween, for example from about 4 mol % to about 6 mol % MgO. In some embodiments, the glasses described herein may comprise from 0 mol % to about 3 mol % ZnO and any ranges or subranges therebetween, for example, from 0 mol % to about 1 mol % ZnO. In some embodiments, the glasses described herein are free of at least one of the divalent oxides CaO and BaO. In some embodiments, the total amount of divalent oxides present in the glass is less than or equal to about 8 mol % (i.e., MgO+CaO+SrO+BaO+ZnO≦8 mol %), less than or equal to about 7 mol %, less than or equal to about 6 mol %, less than or equal to about 5 mol %, or less than or equal to about 4 mol %.

Like SiO₂, ZrO₂ acts as a network former, and is added to increase the annealing and strain points beyond what is achievable using SiO₂ alone. The addition of ZrO₂ serves to reduce stress relaxation during ion exchange and post-ion exchange heat treatment, and simultaneously raising the amount of ZrO₂ increases the modulus and the chemical durability of the glass. In some embodiments, the glasses described herein include 0 mol % ZrO₂, at least 0.25 mol % ZrO₂, at least 0.5 mol % ZrO₂, at least 0.75 mol % ZrO₂, at least 1 mol % ZrO₂, at least 2 mol % ZrO₂, at least 3 mol % ZrO₂, at least 4 mol % ZrO₂, or 5 mol % Li₂O, or any ranges or subranges therebetween. In some embodiments, the glasses described herein comprise from 0 mol % to about 5 mol % ZrO₂; in some embodiments, from 0 mol % to about 3 mol % ZrO₂; in yet other embodiments, from 0.5 mol % to about 3 mol % ZrO₂; and, in other embodiments, from 0.5 mol % to about 5 mol % ZrO₂.

In some embodiments, the alkali aluminosilicate glasses described herein are formable by down-draw processes that are known in the art, such as slot-draw and fusion-draw processes. Glass compositions containing 6 mol % or less of Li₂O are fully compatible with the fusion-draw process and can be manufactured without issue. The lithium may be batched in the melt as either spodumene or lithium carbonate.

The fusion draw process is an industrial technique that has been used for the large-scale manufacture of thin glass sheets. Compared to other flat glass manufacturing techniques, such as the float or slot draw processes, the fusion draw process yields thin glass sheets with superior flatness and surface quality.

The fusion draw process involves the flow of molten glass over a trough known as an “isopipe,” which is typically made of zircon or another refractory material. The molten glass overflows the top of the isopipe from both sides, meeting at the bottom of the isopipe to form a single sheet where only the interior of the final sheet has made direct contact with the isopipe. Since neither exposed surface of the final glass sheet has made contact with the isopipe material during the draw process, both outer surfaces of the glass are of pristine quality and do not require subsequent finishing.

The glasses described herein are chemically compatible with the zircon isopipe and other hardware used in down-draw processes; i.e., the glass melt does not appreciably react to cause zircon to decompose, giving rise to solid inclusions such as zirconia in the drawn glass. In such embodiments, T^{breakdown}—the temperature at which zircon breaks down and reacts with the glass melt—is greater than the temperature at which the viscosity of the glass or glass melt is equal to 35 kiloPoise (T^{35kP}); i.e., T^{breakdown}>T^{35kP}.

In order to be fusion drawable, a glass must have a sufficiently high liquidus viscosity (i.e., the viscosity of a molten glass at the liquidus temperature). In some embodiments, the glasses described herein have a liquidus viscosity of at least about 200 kilopoise (kP) and, in other embodiments, at least about 500 kP.

In another aspect, the glasses described hereinabove are chemically treated to provide a strengthened glass. Ion exchange is widely used to chemically strengthen glasses. In one particular example, alkali cations within a source of such cations (e.g., a molten salt, or “ion exchange,” bath) are exchanged with smaller alkali cations within the glass to achieve a layer that is under a compressive stress (CS) near the surface of the glass. The compressive layer extends from the surface to a depth of layer (DOL) within the glass. In the glasses described herein, for example, potassium ions from the cation source are exchanged for sodium and lithium ions within the glass during ion exchange by immersing the glass in a molten salt bath comprising a potassium salt such as, but not limited to, potassium nitrate (KNO₃). Other potassium salts that may be used in the ion exchange process include, but are not limited to, potassium chloride (KCl), potassium sulfate (K₂SO₄), combinations thereof, and the like. The ion exchange baths described herein may contain alkali ions other than potassium and their corresponding salts. For example, the ion exchange bath may also include sodium salts such as sodium nitrate, sodium sulfate, sodium chloride, or the like.

A cross-sectional schematic view of a planar ion-exchanged glass article is shown in FIG. 1. Glass article 100 has a thickness t, first surface 110, and second surface 112, with the thickness t being in a range from about 0.010 mm (10 μm) to about 0.150 mm (150 μm) or, in some embodiments, in a range from about 0.010 mm (10 μm) to about 0.125 mm (125 μm) or, in still other embodiments, in a range from about 0.010 mm (10 μm) to about 0.100 mm (100 μm). While the embodiment shown in FIG. 1 depicts glass article 100 as a flat planar sheet or plate, glass article may have other configurations, such as three dimensional shapes or non-planar configurations. Glass article 100 has a first compressive layer 120 extending from first surface 110 to a depth of layer d₁ into the bulk of the glass article 100. In the embodiment shown in FIG. 1, glass article 100 also has a second compressive layer 122 extending from second surface 112 to a second depth of layer d₂. Unless otherwise specified, d₁=d₂ and the compressive stress at first surface 110 equals the compressive surface at second surface 112. Glass article also has a central region 330 that extends from d₁ to d₂. Central region 130 is under a tensile stress or central tension (CT), which balances or counteracts the compressive stresses of layers 120 and 122. The depth d₁, d₂ of first and second compressive layers 120, 122 protects the glass article 100 from the propagation of flaws introduced by sharp impact to first and second surfaces 110, 112 of glass article 100, while the compressive stress minimizes the likelihood of a flaw penetrating through the depth d₁, d₂ of first and second compressive layers 120, 122.

The glasses described herein are ion exchangeable to achieve compressive layers 102, 122, having depths of layer d₁, d₂ of up to about 70 μm and a maximum compressive stress CS of at least about 950 MPa at the surfaces 110, 112 of the glass article 100. In some embodiments, the maximum compressive stress at the surfaces 110, 112 of the glass article 100 is at least about 1000 MPa and, in some embodiments, at least about 1100 MPa with depths of layer d₁, d₂ of at least about 40 or 50 μm.

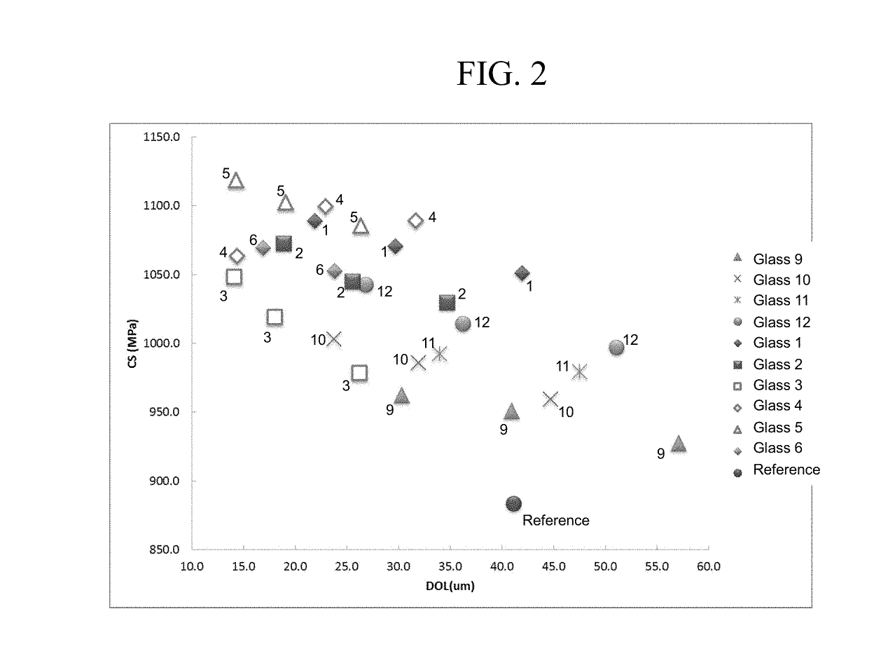

Table 3 lists ion exchange properties of the glasses listed in Table 1 as determined from FSM measurements. The samples were cut out from the melted glass patty and fictivated at 50° C. above their respective annealing points before the ion exchange treatment. The ion exchange treatments were carried out at 410° C. for 4, 8 and 16 hours in an ion exchange bath of approximately 100% KNO₃ by weight. Compressive stress CS at the surface and depth of layer DOL are expressed in units of MPa and μm, respectively. The CS and DOL listed are average values, which were corrected for stress optical coefficient (SOC) and refractive index (RI). Compressive stress CS at the surface and depth of layer DOL of the glasses listed in Table 1 are plotted in FIG. 2. FIG. 2 also includes data obtained for the reference sample, also listed in Table 1.

TABLE 3
Ion exchange properties of glasses listed in Table 1.

| 4 h at 410° C. | Glass 1 | Glass 2 | Glass 3 | Glass 4 | Glass 5 | Glass 6 |
|---|---|---|---|---|---|---|
| CS (MPa) | 1089.2 | 1072.5 | 1048.1 | 1063.3 | 1118.7 | |
| DOL (μm) | 21.9 | 18.9 | 14.1 | 14.4 | 14.3 | |
| 8 h at 410° C. | Glass 1 | Glass 2 | Glass 3 | Glass 4 | Glass 5 | Glass 6 |
| CS (MPa) | 1070.7 | 1044.8 | 1018.6 | 1099.5 | 1102.6 | 1069.4 |
| DOL (μm) | 29.7 | 25.6 | 18.1 | 23.0 | 19.1 | 16.9 |
| 16 h at 410° C. | Glass 1 | Glass 2 | Glass 3 | Glass 4 | Glass 5 | Glass 6 |
| CS (MPa) | 1051.0 | 1029.7 | 978.2 | 1089.2 | 1085.7 | 1052.7 |
| DOL (μm) | 41.9 | 34.7 | 26.3 | 31.7 | 26.4 | 23.8 |
| 4 h at 410° C. | Glass 7 | Glass 8 | Glass 9 | Glass 10 | Glass 11 | Glass 12 |
| CS (MPa) | — | — | 962.5 | 1002.9 | — | 1042.8 |
| DOL (μm) | — | — | 30.3 | 23.8 | — | 26.9 |
| 8 h at 410° C. | Glass 7 | Glass 8 | Glass 9 | Glass 10 | Glass 11 | Glass 12 |
| CS (MPa) | — | — | 950.8 | 985.9 | 992.5 | 1014.1 |
| DOL (μm) | — | — | 40.9 | 31.9 | 34.0 | 36.3 |
| 16 h at 410° C. | Glass 7 | Glass 8 | Glass 9 | Glass 10 | Glass 11 | Glass 12 |
| CS (MPa) | — | — | 927.4 | 959.2 | 979.2 | 997.1 |
| DOL (μm) | — | — | 57.1 | 44.7 | 47.5 | 51.1 |

The glasses described herein may be used in architectural applications such as windows, structural elements, wall panels, or the like. In some applications, such as multi-pane windows, the architectural element must undergo a sealing process following ion exchange. During the sealing process, the ion-exchanged glass is heated up to a temperature at which alkali ion diffusion and stress relaxation are both significant. Thus, compressive stress can be greatly reduced. The continued diffusion of K⁺ ions introduced during ion exchange to deeper depths during the heat treatment is the major contributor to the stress reduction. In the reference glass listed in Table 1, for example, CS will be reduced from 900 MPa to below 600 MPa after a post-ion exchange thermal process in which the glass is heated at a rate of 20° C./min to 450° C., then kept at 450° C. for 1 hour, and finally cooled to 25° C. at a rate of 10° C./min. In other embodiments, the glass may be incorporated into an article with a display (or display articles) (e.g., consumer electronics, including mobile phones, tablets, computers, navigation systems, and the like) to be part of a cover article disposed over the display and/or part of a housing of the article.

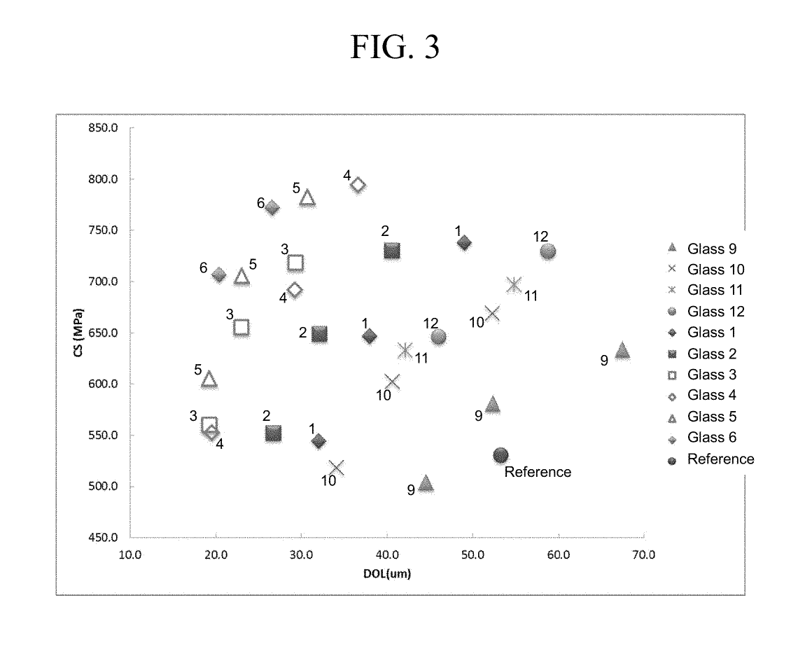

When subjected to post-ion exchange heat treatments identical or similar to that described above, the glasses described herein retain a compressive stress of at least about 600 MPa and, in some embodiments, at least about 750 MPa, at the surface of the glass. Chemically strengthened glasses having the compositions listed in Table 1 were heated at a rate of 20° C./min to 450° C., then held at 450° C. for 1 hour, and then cooled to 25° C. at a rate of 10° C./min. The compressive stresses (CS) and depths of layer (DOL) for these samples were obtained by treatment of annealed samples having a 1 mm thickness in an ion exchange bath of “pure (approximately 100% by weight)” refined grade KNO₃. CS and DOL are listed as average values which were determined by assuming SOC=31.8 and RI=1.5. Compressive stresses and depths of layer of heat-treated ion-exchanged glasses are listed in Table 4 and plotted in FIG. 3. FIG. 3 also includes data measured for the reference glass listed in Table 1. As can be seen from FIG. 3, the glasses described herein, when subjected to a post-ion exchange heat treatment, retain greater compressive stress than the reference glass.

TABLE 4
Compressive stress and depths of layer of heat-treated
ion-exchanged glasses listed in Table 1.

| 4h at 410° C. | Glass 1 | Glass 2 | Glass 3 | Glass 4 | Glass 5 | Glass 6 |
|---|---|---|---|---|---|---|
| CS (MPa) | 544.3 | 551.4 | 559.6 | 552.8 | 605.4 | |
| DOL (μm) | 32.0 | 26.8 | 19.3 | 19.5 | 19.2 | |
| 8 h at 410° C. | Glass 1 | Glass 2 | Glass 3 | Glass 4 | Glass 5 | Glass 6 |
| CS (MPa) | 646.6 | 648.4 | 655.1 | 691.9 | 705.5 | 706.9 |
| DOL (μm) | 38.0 | 32.2 | 23.0 | 29.3 | 23.0 | 20.4 |
| 16 h at 410° C. | Glass 1 | Glass 2 | Glass 3 | Glass 4 | Glass 5 | Glass 6 |
| CS (MPa) | 738.0 | 730.0 | 717.8 | 794.0 | 782.7 | 772.4 |
| DOL (μm) | 49.0 | 40.6 | 29.4 | 36.6 | 30.7 | 26.6 |
| 4 h at 410° C. | Glass 7 | Glass 8 | Glass 9 | Glass 10 | Glass 11 | Glass 12 |
| CS (MPa) | | | 504.1 | 518.2 | | 549.5 |
| DOL (μm) | | | 44.5 | 34.1 | | 38.7 |
| 8 h at 410° C. | Glass 7 | Glass 8 | Glass 9 | Glass 10 | Glass 11 | Glass 12 |
| CS (MPa) | | | 581.0 | 602.4 | 632.9 | 645.9 |
| DOL (μm) | | | 52.3 | 40.6 | 42.1 | 46.1 |
| 16 h at 410° C. | Glass 7 | Glass 8 | Glass 9 | Glass 10 | Glass 11 | Glass 12 |
| CS (MPa) | | | 633.7 | 669.0 | 697.2 | 729.1 |
| DOL (μm) | | | 67.5 | 52.3 | 54.8 | 58.8 |

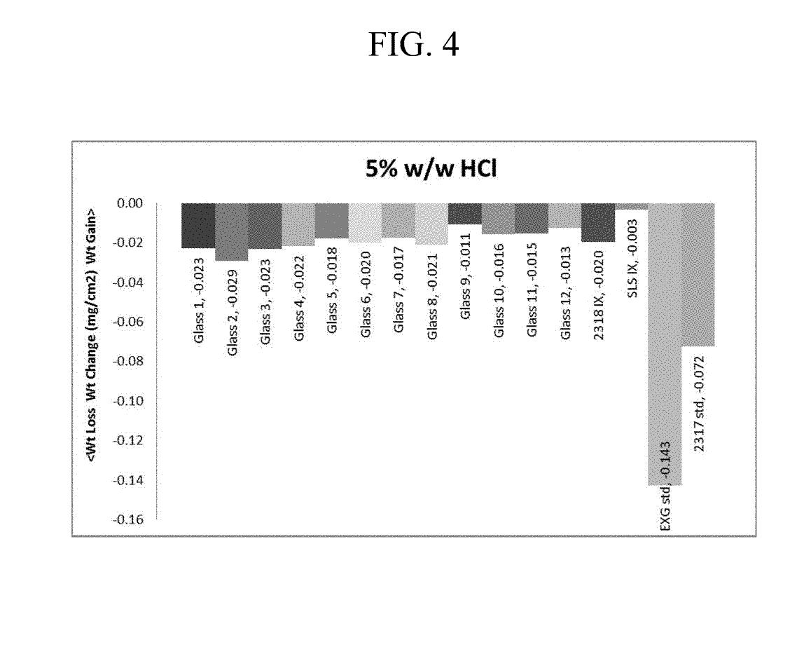

In some embodiments, the glasses described herein may be used as an architectural element such as windows, structural panels, or the like. In some embodiments, the glass may be used in a single- or multi-pane window. Architectural applications also require that the glass have high durability. Chemical durability is typically expressed in terms of weight loss per unit surface area when subjected to prescribed conditions (e.g., immersion in an acid solution comprising about 5 wt % HCl at 95° C. for 7 hours). Accordingly, the glasses described herein exhibit a weight loss of less than or equal to about 0.030 mg/cm² and, in some embodiments, less than 0.020 mg/cm², after immersion in an acid solution comprising about 5 wt % HCl at 95° C. for about 7 hours. Chemical durability of the glasses described herein against a 5% HCL solution is compared to other alkali aluminosilicate glasses (CORNING GORILLA GLASS®, products 2317 and 2318, manufactured by Corning Incorporated, Corning, N.Y.), soda lime silicate (SLS), and borosilicate glass (CORNING EAGLE XG GLASS®, manufactured by Corning Incorporated, Corning N.Y.) in FIG. 4. The samples were kept in the acid solution at 95° C. for 7 hours and then washed in deionized water and dried at 140° C. for at least 30 minutes. The durability of most of the glasses described herein was comparable to or exceeded that of other alkali aluminosilicate glasses, while SLS glass exhibited the greatest degree of durability.

In another aspect, a method of ion exchanging an alkali aluminosilicate glass is provided. The alkali aluminosilicate glass may, in some embodiments, be a glass such as, but not limited to, the glasses described herein above, containing SiO₂, Al₂O₃, Na₂O, MgO, and optionally Li₂O, ZrO₂, and ZnO and being free of at least one of B₂O₃, K₂O, CaO, and P₂O₅. In a first step, the alkali aluminosilicate glass is ion-exchanged in an ion exchange bath comprising a potassium-containing salt. In some embodiments, ion exchange bath comprises essentially 100% potassium salt. The potassium-containing salt, in some embodiments, includes KNO₃. The ion exchange may, in some embodiments, be carried out at about 410° C. for times ranging from about 4 hours to about 16 hours. The ion-exchanged alkali aluminosilicate glass has a compressive layer extending from the surface to a depth of layer and a compressive stress at a surface of the alkali aluminosilicate glass of at least about 950 MPa and a depth of layer of a compressive layer of about 0.25t or less.

In a second step, the ion-exchanged alkali aluminosilicate glass is heat treated for about one hour at a temperature of at least about 400° C. The compressive stress at the surface of the ion-exchanged alkali aluminosilicate glass after the heat treating step is at least about 600 MPa and, in some embodiments, at least about 750 MPa.

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

1. An alkali aluminosilicate glass comprising at least about 50 mol % SiO₂, at least about 10 mol % Na₂O, and MgO, wherein the alkali aluminosilicate glass is free of at least one of K₂O, B₂O₃, CaO, BaO, and P₂O₅, and wherein the alkali aluminosilicate glass experiences a weight loss of less than or equal to about 0.030 mg/cm² after immersion at 95° C. for about 7 hours in an acid solution comprising about 5 wt % HCl.

2. The alkali aluminosilicate glass of claim 1, wherein the alkali aluminosilicate glass has a thickness t of up to about 1 mm and has a compressive layer extending from a surface of the alkali aluminosilicate glass to a depth of layer of up to about 70 μm and a maximum compressive stress of at least about 950 MPa at the surface.

3. The alkali aluminosilicate glass of claim 2, wherein the compressive stress is at least about 1000 MPa and a depth of layer of at least about 40 μm.

4. The alkali aluminosilicate glass of claim 2, wherein the alkali aluminosilicate glass has been heat treated at a temperature of at least about 450° C. following ion exchange and wherein the alkali aluminosilicate glass has a compressive stress at the surface of at least 600 MPa.

5. The alkali aluminosilicate glass of claim 2, wherein the alkali aluminosilicate glass is ion-exchanged and wherein the compressive layer comprises a near-surface region extending from the surface to a depth of 0.20t, and wherein the near-surface region comprises up to about 10 mol % K₂O.

6. The alkali aluminosilicate glass of claim 1, wherein the alkali aluminosilicate glass comprises from about 0.25 mol % to about 6 mol % Li₂O.

7. The alkali aluminosilicate glass of claim 1, wherein the alkali aluminosilicate glass comprises from about 0.5 mol % to about 5 mol % ZrO₂.

8. The alkali aluminosilicate glass of claim 1, wherein the alkali aluminosilicate glass comprises: from about 50 mol % to about 75 mol % SiO₂; from about 7 mol % to about 26 mol % Al₂O₃; from 0 mol % to about 6 mol % Li₂O; from about 10 mol % to about 25 mol % Na₂O; and greater than 0 mol % to about 8 mol % MgO.

9. The alkali aluminosilicate glass of claim 1, wherein the alkali aluminosilicate glass comprises: from about 60 mol % to about 75 mol % SiO₂; from about 7 mol % to about 15 mol % Al₂O₃; from 0 mol % to about 4 mol % Li₂O; from about 10 mol % to about 16 mol % Na₂O; from about 4 mol % to about 6 mol % MgO; from 0 mol % to about 3 mol % ZnO; and from 0 mol % to about 3 mol % ZrO₂.

10. The alkali aluminosilicate glass of claim 1, wherein MgO+CaO+SrO+BaO+ZnO≦8 mol %.

11. The alkali aluminosilicate glass of claim 1, wherein the alkali aluminosilicate glass forms at least a portion of an architectural element or an article with a display.

12. An alkali aluminosilicate glass comprising at least about 50 mol % SiO₂, at least about 10 mol % Na₂O, and MgO, wherein the alkali aluminosilicate glass is free of at least one of K₂O, B₂O₃, CaO, BaO, and P₂O₅, wherein the alkali aluminosilicate glass has a thickness t of up to about 1 mm, is ion-exchanged, and has a compressive layer extending from a surface of the alkali aluminosilicate glass to a depth of layer of up to about 70 μm and a maximum compressive stress of at least about 950 MPa at the surface, and wherein the alkali aluminosilicate glass experiences a weight loss of less than or equal to about 0.030 mg/cm² after immersion in an acid solution at 95° C. for about 7 hours, the acid solution comprising about 5 wt % HCl.

13. The alkali aluminosilicate glass of claim 12, wherein the maximum compressive stress is at least about 1000 MPa.

14. The alkali aluminosilicate glass of claim 12, wherein the alkali aluminosilicate glass has been heat treated at a temperature of at least about 450° C. following ion exchange and wherein the alkali aluminosilicate glass has a compressive stress at the surface of at least 600 MPa.

15. The alkali aluminosilicate glass of claim 12, wherein the alkali aluminosilicate glass comprises from about 0.25 mol % to about 6 mol % Li₂O.

16. The alkali aluminosilicate glass of claim 12, wherein the compressive layer comprises a near-surface region extending from the surface to a depth of 0.20t, and wherein the near-surface region comprises up to about 10 mol % K₂O.

17. The alkali aluminosilicate glass of claim 12, wherein the alkali aluminosilicate glass comprises: from about 50 mol % to about 75 mol % SiO₂; from about 7 mol % to about 26 mol % Al₂O₃; from 0 mol % to about 6 mol % Li₂O; from about 10 mol % to about 25 mol % Na₂O; and greater than 0 mol % to about 8 mol % MgO.

18. The alkali aluminosilicate glass of claim 12, wherein the alkali aluminosilicate glass comprises: from about 60 mol % to about 75 mol % SiO₂; from about 7 mol % to about 15 mol % Al₂O₃; from 0 mol % to about 4 mol % Li₂O; from about 10 mol % to about 16 mol % Na₂O; from about 4 mol % to about 6 mol % MgO; from 0 mol % to about 3 mol % ZnO; and from 0 mol % to about 3 mol % ZrO₂.

19. The alkali aluminosilicate glass of claim 12, wherein MgO+CaO+SrO+BaO+ZnO≦8 mol %.

20. The alkali aluminosilicate glass of claim 12, wherein the alkali aluminosilicate glass forms at least a portion of an architectural element or an article with a display.

21. An alkali aluminosilicate glass comprising: from about 60 mol % to about 75 mol % SiO₂; from about 7 mol % to about 15 mol % Al₂O₃; from about 0.25 mol % to about 4 mol % Li₂O; from about 10 mol % to about 16 mol % Na₂O; from about 4 mol % to about 6 mol % MgO; from 0 mol % to about 3 mol % ZnO; from 0.5 mol % to about 3 mol % ZrO₂; and free of at least one of K₂O and CaO.

22. The alkali aluminosilicate glass of claim 21, wherein the alkali aluminosilicate glass is free of at one or more of B₂O₃, K₂O, CaO, and P₂O₅.

23. The alkali aluminosilicate glass of claim 21, wherein MgO+CaO+SrO+BaO+ZnO≦8 mol %.

24. The alkali aluminosilicate glass of claim 21, wherein the alkali aluminosilicate glass is ion exchangeable to achieve a compressive layer extending from a surface to the depth of layer and having a compressive stress at the surface of at least about 950 MPa.

25. The alkali aluminosilicate glass of claim 24, wherein the compressive stress is at least about 1000 MPa.

26. The alkali aluminosilicate glass of claim 24, wherein the alkali aluminosilicate glass is ion-exchanged and wherein the compressive layer comprises a near-surface region extending from the surface to a depth of 0.20t, and wherein the near-surface region comprises up to about 10 mol % K₂O.

27. The alkali aluminosilicate glass of claim 21, wherein the alkali aluminosilicate glass experiences a weight loss of less than or equal to about 0.030 mg/cm² after immersion in an acid solution at 95° C. for about 7 hours, the acid solution comprising about 5 wt % HCl.

28. The alkali aluminosilicate glass of claim 21, wherein the alkali aluminosilicate glass forms at least a portion of an architectural element or an article with a display.

29. A method of ion exchanging an alkali aluminosilicate glass, the method comprising the steps of:
a. ion exchanging the alkali aluminosilicate glass in an ion exchange bath comprising a potassium-containing salt, wherein the ion-exchanged alkali aluminosilicate glass has a compressive layer having a compressive stress at a surface of the alkali aluminosilicate glass of at least about 950 MPa and a depth of layer of a compressive layer of about 0.25t or less, the compressive layer extending from the surface to the depth of layer; and
b. heat treating the ion-exchanged alkali aluminosilicate glass at a temperature of at least about 400° C., wherein the compressive stress at the surface of the on exchanged alkali aluminosilicate glass after the heat treating step is at least about 600 MPa.

30. The method of claim 29, wherein the compressive stress at the surface of the ion-exchanged alkali aluminosilicate glass after the heat treating step is at least about 750 MPa.
